(19) United States
(12) Patent Application Publication
(10) Pub. No.: US 2006/0082717 A1
(43) Pub. Date: Apr. 20, 2006

(54) Seal pattern for liquid crystal display device and fabrication method thereof

(75) Inventor: Soon-Ku Han, Seoul (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 11/251,853

(22) Filed: Oct. 18, 2005

(30) Foreign Application Priority Data
Oct. 19, 2004 (KR) 2004-0083370

(51) Int. Cl. G02F 1/1339

(52) U.S. Cl. 349/153

(57) ABSTRACT

A liquid crystal display device includes a first substrate, a second substrate opposing the first substrate with the first and second substrates defining a display region and a non-display region. A first seal pattern is provided along a boundary of the display region and the non-display region, and a second seal pattern is provided dividing the display region into a plurality of spaces. A liquid crystal layer is provided between the first and second substrates in the plurality of spaces.

This application claims the benefit of Korean Patent Application No. 10-2004-0083370, filed in Korea on Oct. 19, 2004, which is hereby incorporated by reference.

### BACKGROUND OF THE INVENTION

1. Field of the Invention

The present invention relates to a liquid crystal display device and a fabrication method thereof, and more particularly, to a seal pattern for a liquid crystal display device and a fabrication method thereof.

2. Discussion of the Related Art

A liquid crystal display device includes an array substrate, a color filter substrate and a liquid crystal layer interposed between the array substrate and color filter substrate. The array substrate and color filter substrate respectively have a display region to display images and a non-display region surrounding an edge of the display region.

FIG. 1 is a plan view illustrating a seal pattern of a liquid crystal panel for a liquid crystal display device according to a related art.

As shown in FIG. 1, the liquid crystal panel includes a display region and a non-display region. A dummy region 18 is formed in the non-display region, and a seal pattern 15 for attaching an array substrate to a color filter substrate is formed along a boundary L of the display region and non-display region.

FIG. 2 is a plan view showing an enlargement of zone A in FIG. 1 as viewed from above the color filter substrate of the liquid crystal panel according to the related art.

As shown in FIG. 2, the liquid crystal panel includes a plurality of color filter layers 9 formed on the color filter substrate and a black matrix 7 formed between the color filter layers 9, and a gate line 20 and a data line 22 formed on the array substrate. The gate and data lines 20 and 22 are formed at portions corresponding to the black matrix 7.

FIG. 3 is a cross-sectional view along cross-sectional line I-I′ in FIG. 2 of the liquid crystal panel according to the related art. FIG. 4 is a cross-sectional view along cross-sectional line II-II′ in FIG. 2 of the liquid crystal panel according to the related art.

As shown in FIGS. 3 and 4, the gate line 20 of FIG. 4 and the data line 22 which perpendicularly cross each other to define a pixel, a thin film transistor T disposed at the crossing of the two lines, and a pixel electrode 11 are formed on a first substrate 1. The black matrix 7 for preventing light leakage, the color filter layer 9 of red(R), green(G) and blue(B) for displaying colors, an overcoat 17, and a common electrode 13 are formed on a second substrate 3. The thin film transistor T includes a gate electrode, an active layer and source and drain electrodes. The first and second substrates 1 and 3 face each other with a liquid crystal layer 5 interposed therebetween.

The black matrix 7 is formed corresponding to the gate and data lines 20 and 22 and the thin film transistor T in the display region. The display region has a pixel region P for displaying images that are viewed by an observer through a molecular arrangement of the liquid crystal, and has a non-pixel region NP that includes the thin film transistor T. The first substrate 1, including the thin film transistor T and the pixel electrode 11, is an array substrate. The second substrate 3, including the black matrix 7, the color filter layer 9, the overcoat 17 and the common electrode 13, is a color filter substrate.

An interval between the first and second substrates 1 and 3, i.e., a cell gap, defines a thickness of the liquid crystal layer 5 and should be maintained uniformly. To accomplish this, a spacer (not shown) is disposed between the first and second substrates 1 and 3. A seal pattern 15 is formed along a boundary of the display region and non-display region to join the first and second substrates 1 and 3 together with the liquid crystal layer 5 interposed between the first and second substrates 1 and 3 inside the seal pattern 15. The seal pattern 15 is formed on one of the first and second substrates 1 and 3.

Next, the liquid crystal layer 5 is formed on one of the first and second substrates 1 and 3 by a dispensing method, and the two substrates 1 and 3 are attached using the seal pattern 15. The attaching process includes a hardening process of the seal pattern 15. In other words, the seal pattern 15 is hardened by applying heat to the substrates while pressurizing and attaching the substrates.

However, when the seal pattern is formed as described, the larger the liquid crystal panel becomes, the broader a dispensing area of the liquid crystal becomes. As a result, it is difficult to accurately determine a quantity of liquid crystal to be dispensed, and a spreading degree of the liquid crystal goes down. In addition, the liquid crystal tends to move and gather in an incline depending on the direction or angle in which the liquid crystal panel is position.

### SUMMARY OF THE INVENTION

Accordingly, the present invention is directed to a seal pattern for a liquid crystal display device that substantially obviates one or more of problems due to limitations and disadvantages of the related art.

An object of the present invention is to provide a liquid crystal display device configuration that permits an accurate and simple determination of a quantity of liquid crystal to be dispensed in a dispensing area by subdividing a large-sized liquid crystal panel with a seal pattern.

An another object of the present invention is to provide liquid crystal display device that improves an amount of spreading of a liquid crystal in a dispensing area by subdividing a large-sized liquid crystal panel with a seal pattern.

An another object of the present invention is to provide a liquid crystal display device that prevents movement of liquid crystal according to the placement of the panel by subdividing a large-sized liquid crystal panel with a forming of a seal pattern.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a liquid crystal display device comprises a first substrate; a second substrate opposing the first substrate, the first and second substrates defining a display region and a non-display region; a first seal pattern disposed along a boundary of the display region and the non-display region; a second seal pattern dividing the display region into a plurality of spaces; and a liquid crystal layer disposed between the first and second substrates in the plurality of spaces.

In another aspect, a fabrication method of a liquid crystal display device comprises forming a first seal pattern at a boundary of a display region and a non-display region of one of first and second substrates; forming a second seal pattern in the display region of one of the first and second substrates, the second seal pattern dividing the display region into a plurality of spaces; forming a liquid crystal layer on one of the first and second substrates; and attaching the first and second substrates to each other with the liquid crystal layer, the first seal pattern, and the second seal pattern between the first and second substrates.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a plan view illustrating a seal pattern of a liquid crystal panel for a liquid crystal display device according to the related art;

FIG. 2 is a plan view showing an enlargement of zone A in FIG. 1 according to the related art;

FIG. 3 is a cross-sectional view along cross-sectional line I-I′ in FIG. 2 according to the related art;

FIG. 4 is a cross-sectional view along cross-sectional line II-II′ in FIG. 2 according to the related art;

FIG. 5 is a plan view illustrating a seal pattern of a liquid crystal panel for a liquid crystal display device according to an exemplary embodiment of a present invention;

FIG. 6 is a plan view illustrating an enlargement of zone B in FIG. 5 for a TN mode liquid crystal panel according to an exemplary embodiment of the present invention;

FIG. 7 is a plan view illustrating an enlargement of zone B for an IPS mode liquid crystal panel according to an exemplary embodiment of the present invention;

FIG. 8 is a cross-sectional view along cross-sectional line III-III′ in FIG. 6 according to an exemplary embodiment of the present invention; and

FIG. 9 is a cross-sectional view along cross-sectional line IV-IV′ in FIG. 6 according to an exemplary embodiment of the present invention.

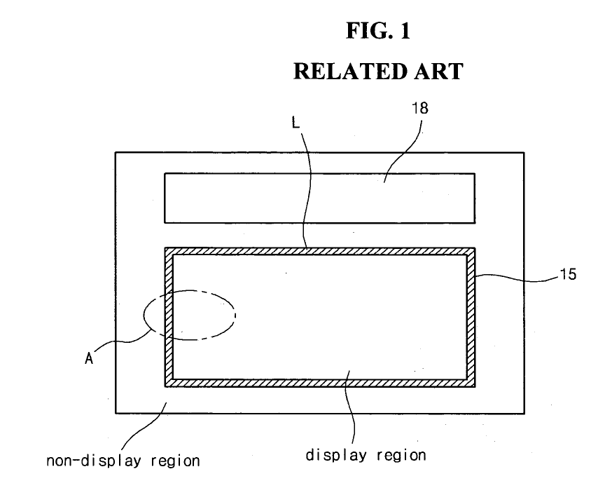

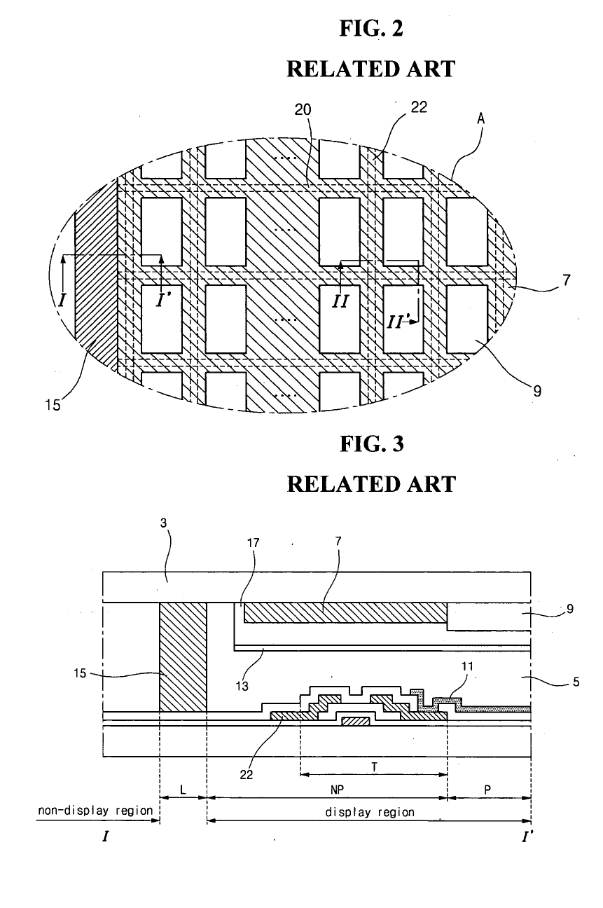

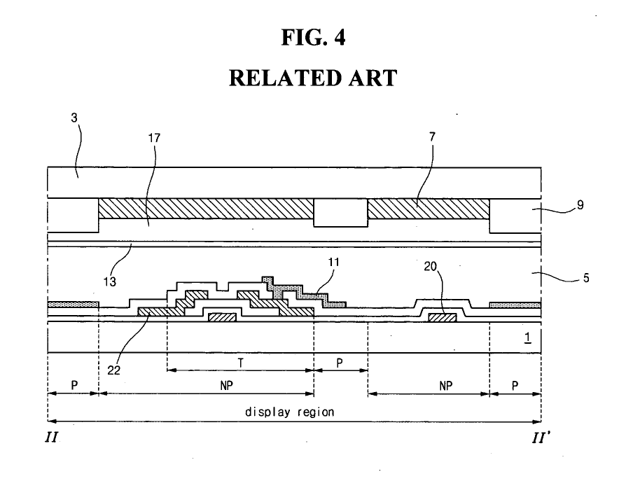

### DETAILED DESCRIPTION OF THE PREFERRED EMBODIMENTS

Reference will now be made in detail to the illustrated embodiments of the present invention, which are illustrated in the accompanying drawings.

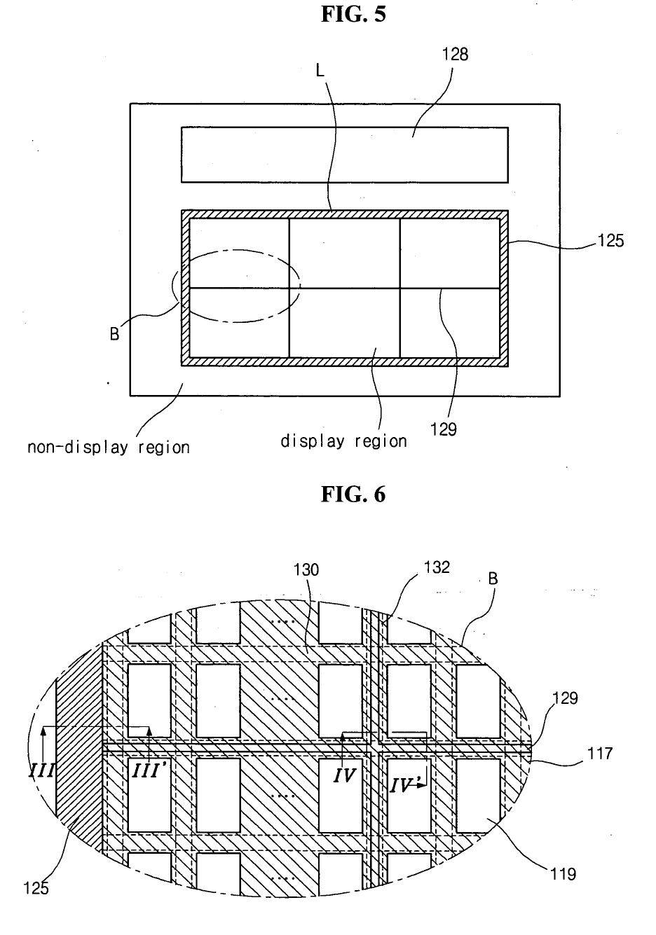

FIG. 5 is a plan view illustrating a seal pattern of a liquid crystal panel for a liquid crystal display device according to an exemplary embodiment of a present invention.

As shown in FIG. 5, the liquid crystal panel includes a display region and a non-display region. A dummy region 128 is formed in the non-display region, and a first seal pattern 125 for attaching an array substrate and a color filter substrate is formed along a boundary L of the display region and non-display region. In addition, a second seal pattern 129 is formed in the display region at portions corresponding to a black matrix.

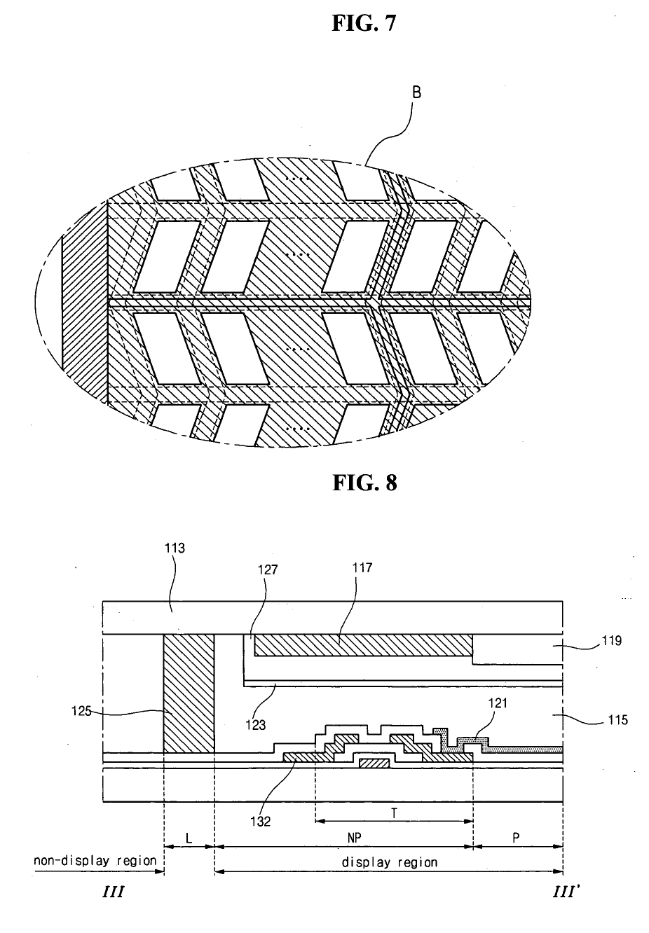

FIG. 6 is a plan view illustrating an enlargement of zone B of FIG. 5 for a TN mode liquid crystal panel according to an exemplary embodiment of the present invention. FIG. 7 is a plan view illustrating an enlargement of zone B of FIG. 5 for an IPS mode liquid crystal panel according to an exemplary embodiment of the present invention. FIGS. 6 and 7 are viewed from above the color filter substrate.

As shown in FIG. 6, the liquid crystal panel includes a plurality of color filter layers 119 formed on the color filter substrate and a black matrix 117 formed between the color filter layers 119, and a gate line 130 and a data line 132 formed on the array substrate. The gate and data lines 130 and 132 are formed corresponding to the black matrix 117. In addition, a second seal pattern 129 is formed corresponding to the gate and data lines 130 and 132 with a smaller width than a width of the gate and data lines 130 and 132.

Since the liquid crystal may flow to the subdivided adjoining space when the second seal pattern 129 is formed into a dotted line with gap, the second seal pattern 129 should be formed as a full line without gap. In this way, subdivided adjoining spaces are isolated from each other. In addition, the width of the second seal pattern 129 is within a range of about ½ to ¾ of the black matrix 117, thereby minimizing a seal stain caused by the second seal pattern 129.

The second seal pattern 129 subdivides the display region of the liquid crystal panel in small-sized units. Accordingly, since a liquid crystal panel larger than 50 inches has the subdivided spaces, a quantity of the liquid crystal to be dispensed for the liquid crystal panel may be easily figured, and an inclining of the liquid crystal according to the direction putting the liquid crystal panel may be prevented.

The second seal pattern 129 in a large area liquid crystal panel is desirable so that the liquid crystal panel may be subdivided into portions having a small size. Because of difficulties in attaching the first and second substrates, the subdivided space desirably has a size of about 15 to 18 inches.

The present invention may be applied to an IPS (In-plane switching) mode liquid crystal display device as shown in FIG. 7, as well as an TN (twisted nematic) mode liquid crystal display device as shown in FIG. 6.

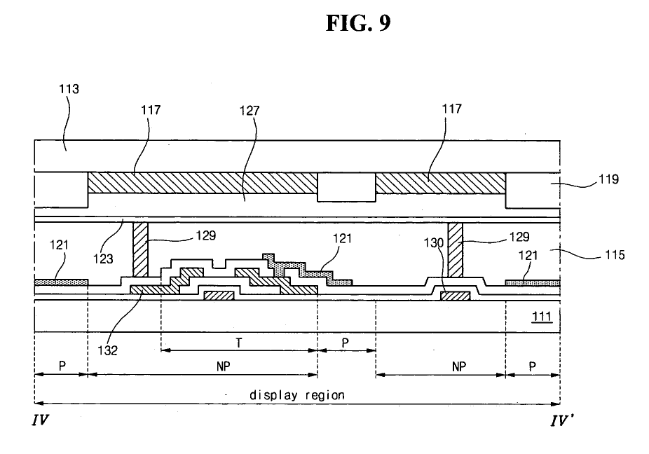

FIG. 8 is a cross-sectional view along cross-sectional line III-III′ in FIG. 6 according to the exemplary embodiment of the present invention. FIG. 9 is a cross-sectional view along cross-sectional line IV-IV′ in FIG. 6 according to the exemplary embodiment of the present invention.

As shown in FIGS. 8 and 9, the liquid crystal panel includes first and second substrates 111 and 113 having the display region and the non-display region surrounding the display region respectively, and a liquid crystal layer 115 interposed the first and second substrates 111 and 113. On the first substrate, the liquid crystal panel further includes the gate line 130 of FIG. 9 and the data line 132 perpendicularly crossing each other to define a pixel, a thin film transistor T at the crossing of the two lines and a pixel electrode 121. The black matrix 117 for preventing light leakage, the color filter layer 119 of red(R), green(G) and blue(B) for displaying colors, an overcoat 127, and a common electrode 123 are formed on the second substrate 113. The thin film transistor T includes a gate electrode, an active layer and source and drain electrodes. The first and second substrates 111 and 113 face each other with a liquid crystal layer 115 interposed therebetween.

The black matrix 117 is formed at portions corresponding to the gate and data lines 130 and 132 and the thin film transistor T in the display region. The display region has a pixel region P for displaying images to be viewed by an observer through a molecular arrangement of the liquid crystal, and a non-pixel region NP including the thin film transistor T. The first substrate 111 having the thin film transistor T and the pixel electrode 121 is an array substrate, the second substrate 113 including the black matrix 117, the color filter layer 119, the overcoat 127 and the common electrode 123 is a color filter substrate.

An interval between the first and second substrates 111 and 113, i.e., a cell gap, defines a thickness of the liquid crystal layer 115 and should be uniform. To accomplish this, a spacer (not shown) is disposed between the first and second substrates 111 and 113. A first seal pattern 125 is formed along a boundary of the display region and non-display region to join the first and second substrates 111 and 113 with the liquid crystal layer 115 interposed therebetween. In addition, a second seal pattern 129 is formed in the non-pixel region NP of the display region. In other words, the first seal pattern 125 is formed at the boundary L of the display region and non-display region of the liquid crystal panel, and the second pattern 129 is formed at portions corresponding to the black matrix 117 of the display region of the liquid crystal panel, the gate line 130 and data line 132. The width of the second seal pattern 129, as described above, is within a range of about ½ to ¾ of the black matrix 117 and has a smaller width than the width of the gate and data lines 130 and 132. The first and second seal patterns 125 and 129 respectively are formed on one of the first and second substrates 111 and 113.

After the seal patterns are formed, the liquid crystal layer 115 is formed. To solve disadvantages of a vacuum injection method of the liquid crystal according to related art, the liquid crystal layer 115 of the present invention is formed by the dispensing method that is presently suggested. The dispensing method is not accomplished by injecting the liquid crystal by a pressure difference between the inside and the outside of the panel, but by dispensing and dividing the liquid crystal directly on the substrate, and uniformly distributing the dispensed liquid crystal by an attaching pressure of the panel throughout the whole surface of the panel. Since the dispensing method dispenses the liquid crystal directly onto the substrate during a short time, the liquid crystal layer of the liquid crystal display device with large area is formed quickly. In addition, since only a needed quantity of the liquid crystal is dispensed directly onto the substrate, consumption of the liquid crystal may be minimized, thereby curtailing manufacturing expenses. The liquid crystal layer 115 may be formed on either one of the first and second substrates 111 and 113, the first and second seal patterns 125 and 129 can be formed on the same or the other substrate.

Next, the first and second substrates are attached to each other. Attaching includes a hardening process of the first and second seal patterns 125 and 129. In other words, the first and second seal patterns 125 and 129, having a heat hardening resin, are hardened by applying heat to the substrates when pressurizing and attaching the substrates. After attaching, the liquid crystal layer 115 and the second seal pattern 129 may have a same thickness.

Although not shown, the first substrate may further include a thin film transistor, a pixel electrode and a common electrode. The second substrate may further include a color filter layer, such as the IPS mode liquid crystal display device. Furthermore, although not shown, the first substrate may include a thin film transistor, a color filter layer and a pixel electrode, such as a color filter on thin film transistor (COT) mode or a thin film transistor on a color filter (TOC) mode liquid crystal display device.

It will be apparent to those skilled in the art that various modifications and variations can be made in the seal pattern for a liquid crystal display device and fabrication method thereof of the present invention without departing from the spirit or scope of the invention. Thus, it is intended that the present invention cover the modifications and variations of this invention provided they come within the scope of the appended claims and their equivalents.

What is claimed is:

1. A liquid crystal display device, comprising:
a first substrate;
a second substrate opposing the first substrate, the first and second substrates defining a display region and a non-display region;
a first seal pattern disposed along a boundary of the display region and the non-display region;
a second seal pattern dividing the display region into a plurality of spaces; and
a liquid crystal layer disposed between the first and second substrates in the plurality of spaces.

2. The device according to claim 1, wherein the second substrate includes a black matrix disposed at portions corresponding to the second seal pattern.

3. The device according to claim 2, wherein a width of the second seal pattern is within a range of about ½ to ¾ of a width of the black matrix.

4. The device according to claim 1, wherein the first substrate includes gate and data lines disposed at portions corresponding to the second seal pattern.

5. The device according to claim 4, wherein a width of the second seal pattern is smaller than a width of the gate and data lines.

6. The device according to claim 1, wherein the first substrate includes a thin film transistor and a pixel electrode, and wherein the second substrate includes a color filter layer and a common electrode.

7. The device according to claim 1, wherein the first substrate includes a thin film transistor, a pixel electrode and a common electrode, and wherein the second substrate includes a color filter layer.

8. The device according to claim 1, wherein the first substrate includes a thin film transistor, a color filter layer, and a pixel electrode.

9. The device according to claim 1, wherein the plurality of spaces are isolated from each other.

10. The device according to claim 1, wherein the second seal pattern is disposed in the non-pixel region of the display region.

11. A fabrication method of a liquid crystal display device, comprising:
forming a first seal pattern at a boundary of a display region and a non-display region of one of first and second substrates;
forming a second seal pattern in the display region of one of the first and second substrates, the second seal pattern dividing the display region into a plurality of spaces;
forming a liquid crystal layer on one of the first and second substrates; and
attaching the first and second substrates to each other with the liquid crystal layer, the first seal pattern, and the second seal pattern between the first and second substrates.

12. The method according to claim 11, wherein the first and second seal patterns are formed on the same one of the first and second substrates.

13. The method according to claim 11, wherein the first and second seal patterns are formed on different ones of the first and second substrates.

14. The method according to claim 11, wherein the second seal pattern and the liquid crystal layer have the same height.

15. The method according to claim 11, wherein the second substrate includes a black matrix disposed at portions corresponding to the second seal pattern.

16. The method according to claim 15, wherein a width of the second seal pattern is within a range of about ½ to ¾ of a width of the black matrix.

17. The method according to claim 11, wherein the first substrate includes gate and data lines corresponding to the second seal pattern.

18. The method according to claim 17, wherein a width of the second seal pattern is smaller than a width of the gate and data lines.

19. The method according to claim 11, wherein the liquid crystal is formed by a dispensing method.

20. The method according to claim 11, wherein the first substrate includes a thin film transistor and a pixel electrode, and wherein the second substrate includes a color filter layer and a common electrode.

21. The method according to claim 11, wherein the first substrate includes a thin film transistor, a pixel electrode and a common electrode, and wherein the second substrate includes a color filter layer.

22. The method according to claim 11, wherein the first substrate includes a thin film transistor, a color filter layer, and a pixel electrode.

23. The method according to claim 11, wherein the plurality of spaces are isolated from each other by the second seal pattern.

24. The method according to claim 11, wherein the second seal pattern is disposed in the non-pixel region of the display region.
